(19) United States
(12) Patent Application Publication
(10) Pub. No.: US 2007/0154041 A1
(43) Pub. Date: Jul. 5, 2007

(54) Integrated entertainment system with audio modules

(76) Inventor: Todd Beauchamp, Poway, CA (US)

Correspondence Address: NATH & ASSOCIATES, PLLC, 112 SOUTH WEST STREET, Alexandria, VA, 22314, US

(21) Appl. No.: 11/325,485

(22) Filed: Jan. 5, 2006

(51) Int. Cl. H04R 5/02; H04R 9/06; H04R 1/02

(52) U.S. Cl. 381/306; 381/333; 381/388

(57) ABSTRACT

In a home entertainment system, a plurality of modules having diverse functions, e.g., tuners, media player/recorders, amplifiers and a surround sound unit, are integrated in a single enclosure. A unitary system is provided rather than one with many modules requiring additional space. The modules may share a common power supply and heat dissipation components. The enclosure comprises a stand on which a video display unit, such as a television set is supported. A support, such as a shelf, and an interface may be provided for a discrete component such as a cable box. In a further form, the enclosure need not necessarily support a video display unit. A further embodiment also houses a center channel speaker unit in a structure attached to or unitary with the enclosure. The center channel speaker unit may also be provided as a stand-alone unit.

### CROSS-REFERENCE TO RELATED APPLICATIONS

The present application claims priority to U.S. Provisional Patent Application Ser. No. 60/632,187 filed Jan. 6, 2005, the disclosure of which is incorporated herein by reference in its entirety.

### FIELD OF THE INVENTION

The present subject matter relates generally to entertainment systems, for example home entertainment systems, and to audio subsystems therein.

### BACKGROUND OF THE INVENTION

Home entertainment systems generally include components for receiving, detecting and demodulating audio and video signals, players for playing various forms of media, video displays and audio amplifiers, processors and speakers. In most conventional systems, components such as a radio tuner, digital video disc (DVD) player/recorder, cable television box and audio units are provided as separate modules, each on its own chassis and in its own enclosure. Some degree of integration has been provided in systems known as a home theater in a box. Many of the disadvantages described below are still present. An apparatus is a home entertainment system by virtue of its being able to read media and to process and amplify signals and to provide audiovisual outputs. A home entertainment system need not be located in a home. A home entertainment system may be part of a home theater. One definition of a home theater is a home entertainment system that provides an experience similar to viewing in a cinema, namely brilliant, sharp, large video images with enveloping surround sound. A home theater system comprises a screen display, a surround sound system and a source or sources for movie content such as a DVD player, which further comprises audio speakers and visual displays. For purposes of the present description, a home entertainment system is not distinguished from a home theater.

In one popular form of home entertainment system, a television set, or other video monitor, is featured as the center of attention. In this form, the television set is supported on a stand. The stand further comprises shelves, usually below the surface that supports the television set. Alternatively, a home entertainment system may comprise a home entertainment unit rather than a stand. A typical home entertainment unit is a piece of furniture comprising a rectangular enclosure in which shelves are mounted. The various components are supported on the shelves. A typical system may also comprise a radio tuner, television set or television tuner and monitor, audio amplifier, audio preamplifier or “surround sound” unit, a video disc player, subwoofer (low frequencies), midbass driver (mid bass frequencies), midrange driver (mid frequencies), tweeters (high frequencies) which may form the center channel, left, right, surrounds, and subwoofer speaker units. An example of such a television stand is illustrated in U.S. Pat. No. 5,216,211. It is noted that the terms high, mid and low frequency are relative, and do not necessarily specify a particular range of frequencies. Audio environments utilize a number of speakers which interact. Generally there are left, center, right, left rear, right rear and subwoofer speakers. Newer arrangements comprising additional speakers are coming into use.

The conventional practice of providing a number of components has a number of consequences. Each component is generally dedicated to one function, such as tuning, amplifying or decoding signals. The components comprise modules of a system. Each of the modules must be connected to one or more other modules. This may result in a veritable “rat's nest” of wires behind the home entertainment system. Technically unsophisticated users may have to take a great deal of time to make the proper interconnections. In addition, most of the modules have their own separate line cords for connection to AC power. Generally, an additional wiring device, e.g., a power strip, is required to connect the modules to a wall outlet. In older homes, the total current draw of the different devices may provide a burden on an individual power circuit. The array of modules takes up more space than an integrated unit would take up. Some modules are designed to have decorative value and may be the subject of design patents. In other systems, combinations of modules that are functionally well matched may have an aesthetically displeasing appearance due to dissimilarity in external design.

The prior art has not provided integrated systems. U.S. Pat. No. 5,194,963 discloses two video cassette decks in a single housing. While there are two units in one housing that have each previously been included in separate housings, the single housing is still dedicated to video recording and video playing. A central purpose of this apparatus is to enable tape-to-tape reproduction in a manner avoiding degradation of video information content. A multifunction system is not integrated into one housing.

U.S. Pat. No. 6,741,708 avoids the problems of the tangle of wires behind a home entertainment unit by interconnecting modules, speakers or other components through wireless coupling. This approach entails the expense of transmitters and receivers. The provision of a number of wireless radio frequency sources requires use of a number of frequency bands or coding schemes, which increases system complexity. Wireless units may also produce interference with other wireless units or with tuners and amplifiers in a system. Having to interconnect separate components wirelessly leaves fewer frequencies open for use in coupling to speakers.

In prior systems, the electronics modules and the subwoofer units have not been integrated. One disincentive for such integration is the mechanically deleterious effects on electronics modules of vibrations produced by the subwoofer.

Another shortcoming of the prior art is in the construction of the center channel. The center channel is a loudspeaker system that may comprise of a plurality of drivers reproducing a center frequency range, also referred to as the center channel. The center channel frequency range sent by a surround sound processor is the range in which voices and most musical tones fall. Different manufacturers specify different frequency ranges for the center channel. However, one nominal center channel range is 100 Hz-20 KHz. Center channel speaker units have not been integrated into stands and home entertainment units. They may be supported on a stand.

U.S. Pat. No. 6,672,465 discloses a television stand having an upper surface to support a television set and a lower shelf that can support entertainment modules. A shelf intermediate the lower shelf and the upper surface supports and magnetically shields a center channel speaker unit. This construction requires that one shelf be dedicated to the center channel speaker unit. The illustrated center channel speaker unit is constrained to have a width less than that of the shelf. Size constraints of the center channel also constrain the level of acoustical power that can be supplied from the center channel. To produce desired sound levels, center channel output must combine both in frequency and sound pressure level (SPL) with outputs from subwoofers. The smaller center channels may not be capable of delivering the same high SPL levels of the subwoofer. Therefore the power that the subwoofer is designed to provide must also be limited to stay at the lower SPL limits of the center channel. If the subwoofer is not limited and continues to be played louder than the center channel, the bass may become overbearing and sound unnatural. The total system performance either suffers by unnatural sound or limited maximum sound output depending on the system design.

Generally, it is difficult to obtain comparable performance out of a smaller center channel speaker unit than a larger one. Constraints of this system limit both the size of the center channel speaker unit and the number of modules that can be stored on the shelves of the television stand. One particular aspect of this shortcoming is that the SPL output of a small bass speaker in the center channel unit must be blended with the output of a subwoofer frequency and SPL. The subwoofer requires floor space in addition to that required by the stand. The small speaker's maximum sound pressure level (SPL) at a low frequency is lower than that of a larger speaker. The level of audio output applied to drive the small speaker must be limited so as not to overdrive the small speaker. The limitation of audio output limits performance of the entire speaker array. In smaller designs of center channels, another commonly encountered drawback is that sound must be projected from speakers into cabinet walls of the stand they are mounted in.

### SUMMARY OF THE INVENTION

Briefly stated, in accordance with embodiments of the present invention, a home entertainment system is provided in which a plurality of modules having diverse functions are integrated in a single enclosure. The modules may share a common power supply and heat dissipation components. The enclosure comprises a stand on which a video display unit such as a television set may be supported. A support, such as a shelf, and an interface may be provided for a discrete component such as a cable box. A center channel speaker unit may be supported between the enclosure and the shelf.

In a further form, the center channel speaker unit provides for optimum placement of speakers for a given size enclosure and superior acoustic summation to the subwoofer in the enclosure. The optimum center channel placement may also provide superior sound imaging to the TV display. The center channel speaker unit may also be provided as a stand-alone unit.

### BRIEF DESCRIPTION OF THE DRAWINGS

FIG. 1 is a perspective view of a system in accordance with an embodiment of the invention in an operating environment;

FIG. 2 is a front axonometric view of a similar embodiment;

FIG. 3 is a rear axonometric view of another similar embodiment;

FIG. 4 is a partial detailed axonometric view illustrating one form of the modular shelf and center channel

FIG. 5 is a cross sectional elevation taken along line 5-5 of FIG. 2;

FIG. 6 is a plan view of the apparatus of FIG. 5;

FIG. 7 is a block diagram of one form of the present invention;

FIG. 8 is an axonometric view of a center channel speaker unit

FIG. 9 is a cross sectional side elevation taken along line 9-9 of FIG. 8.

### DETAILED DESCRIPTION

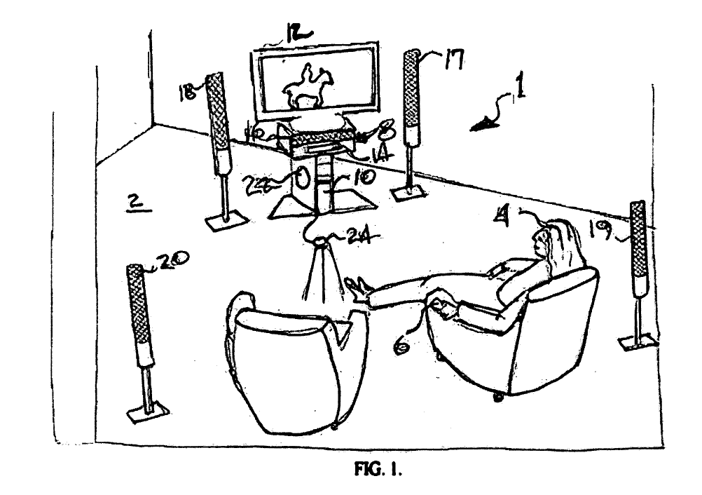

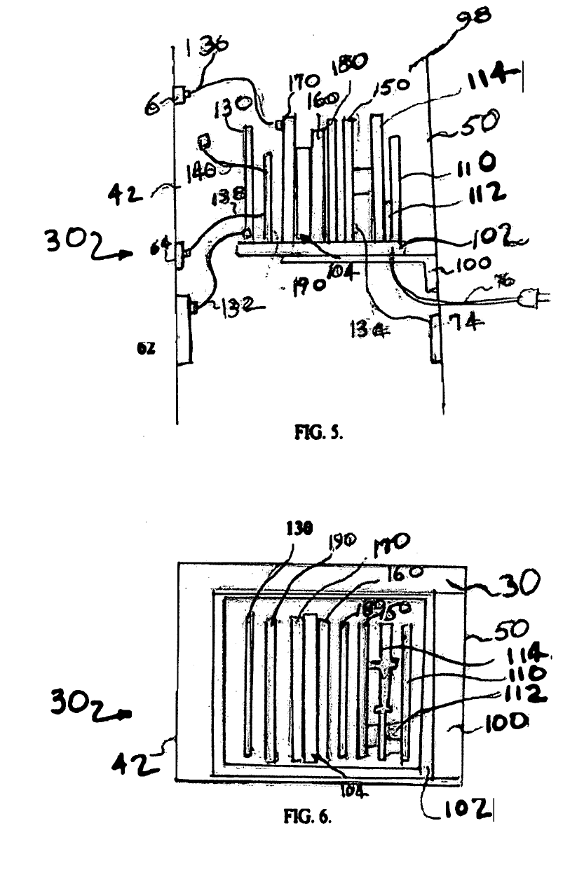

A home entertainment environment 1 located in a room 2 is described in general with respect to FIG. 1. A user 4 may utilize a remote control unit 6 to control operation. The home entertainment environment 1 comprises the apparatus, which creates an entertainment experience for the user 4. The home entertainment environment 1 comprises a home entertainment system 10 and may comprise a video display 12. The video display 12 may be part of a television set including tuners and an amplifier. Alternatively, the video display 12 could comprise a video monitor. The home entertainment system 10 is housed in a modular base 8. The home entertainment system 10 comprises components which provide different functions and which are integrated. Particular modules in the home entertainment unit 10 are described in further detail with respect to FIGS. 5 and 6. At the present time, commonly provided components include a radio tuner, digital video disc (DVD) player/recorder, compact disc (CD) audio player/recorder, digital video recorder (DVR), amplifiers and other audio units. It is foreseeable that other forms of media players will supersede present forms. Audio units may comprise amplifiers; surround sound units and other components for processing audio signals. In accordance with embodiments of the present invention, modules are integrated within the home entertainment system 10.

A subscriber interface unit 14 may be provided for connection to the home entertainment system 10. The subscriber interface unit 14 could comprise a cable box, satellite television tuner, video-on-demand box or other source of media. The subscriber interface unit 14 could be included in the home entertainment system 10. However, most homes utilize an interface unit provided by and belonging to a media provider. Therefore, subscriber interface unit 14 will generally, although not necessarily, be a component separate from the home entertainment system 10.

Audio is generally provided by a speaker array. Many different forms of speaker arrays may be provided. In one conventional array, a center channel 16 is provided in a location in horizontal registration with the home entertainment system 10. Prior systems may locate the center channel 16 on a shelf in the home theater 10 or on top of the video monitor 12, for example. Right and left speakers 17 and 18 are located on either side of the television monitor. First and second surround sound speakers 19 and 20 are located on either side of the video monitor 12 and displaced from the video monitor so as to be placed behind a user 4. In alternative systems coming into greater use, the speakers 19 and 20 need not be behind the user 4. A subwoofer 22 is usually located at or near floor level in the vicinity of the video monitor 12. Additionally, the home entertainment environment 1 may comprise a microphone 24 placed in a reference position in the room 2, for example, at a listening position in the room 2. The microphone 24 provides a feedback signal to an acoustic room correction feature in the home entertainment system 10. The acoustic room correction feature may adjust equalization of various speakers. Acoustic processing may include psychoacoustic processing. Psychoacoustic processing takes in to account differences in perceived sound from sound that is theoretically harmonious based on relationships of frequency components included in the sound.

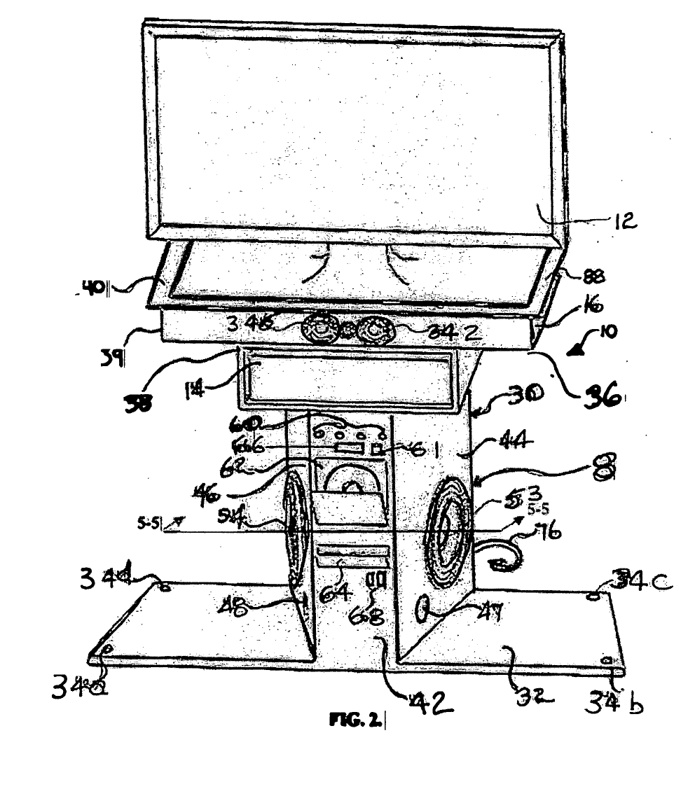

FIG. 2 is a perspective front view of a home entertainment system 10, which is similar in shape but not identical to the embodiment of FIG. 1. The home entertainment system 10 comprises a first enclosure 30. The first enclosure 30 may be fastened to and supported on a base plate 32. The base plate 32 provides stability to prevent the first enclosure 30 from tipping over. Leveling adjusters 34a-34d may provide adjustment for each corner of the base plate 32 to provide for leveling the home entertainment system 10. In the present illustration, the base plate 32 is rectangular. In the illustration of FIG. 1, the base plate 32 is trapezoidal. Both functional and ornamental features may be included in the base plate 32. Alternatively, in the absence of a base plate 32, ballast may be provided at a bottom of the first enclosure 30 to create a low center of gravity to provide for stability. However, when a large video monitor 12 is to be supported at a top of the first enclosure 30, providing a sufficiently large weight of ballast may be impractical, and stability is provided by using a sufficiently wide base plate 32. Sufficient width is determined by the force moment about a center of the base plate 32 exerted by a center of gravity of the home entertainment system 10. First enclosure 30 width may be increased to provide adequate support for the video display 12 without the use of base plate 32.

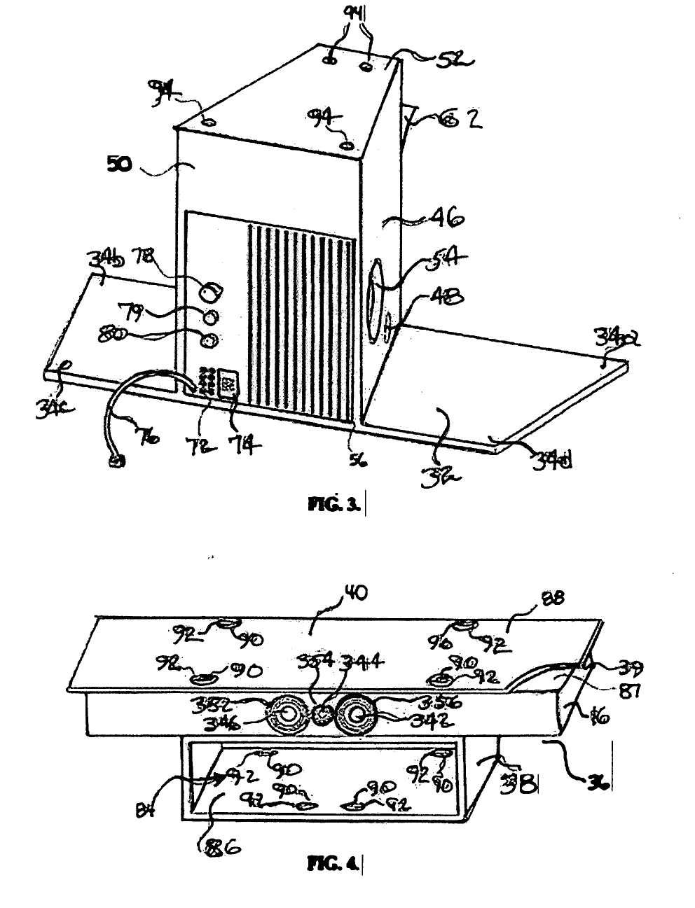

Mounted above the first enclosure 30 is a housing unit 36. As further described below with respect to FIG. 4, the housing unit 36 may comprise a rectangular modular shelf unit 38 to support the subscriber interface unit 14 and may also have a closed portion 39 comprising the center channel 16 and may also comprise an upper support base 88. A support surface 40 is provided on which the video monitor 12 may be placed. The support surface 40 may comprise an upper surface of an upper support base 88 having a width greater than the housing unit 36 or may simply comprise a top of the housing unit 36. Taken together, the first enclosure 30 and the housing unit 36 comprise the modular base 8.

The first enclosure 30 is further described with respect to FIGS. 2 and 3. FIG. 3 is a rear perspective view of another form of the first enclosure 30 shown separately from the housing unit 36. The first enclosure 30 may have any of a number of shapes for its horizontal cross section. In the illustration of FIG. 2, the cross section comprises a trapezoid. In the illustrations, the first enclosure 30 comprises a front panel 42, a right panel 44, a left panel 46 and a rear panel 50. Terms such as front and rear are used to describe relative location. They do not indicate position with respect to a datum. In the present illustration, the positions are labeled to correspond to orientation as viewed by the user 4. The first enclosure 30 has a top surface 52. An electronics plate 56 may be located in an opening in the rear panel 50. The electronics plate 56 serves to support various components inside the first enclosure 30 and to allow access to various controls and other components from outside of the first enclosure 30, as further described below.

The first enclosure 30 may house first and second subwoofers 53 and 54 (FIG. 2) housed in side panels 44 and 46 respectively. By integrating the subwoofers 53 and 54 into the first enclosure 30, space that would be wasted in a traditional television stand is used to provide a subwoofer enclosure. The need for a second, bulky, separate unit is eliminated. Subwoofers are a source of low-frequency vibration that could potentially have a deleterious effect on components in the first enclosure 30. By mounting the subwoofers 53 and 54 substantially in spatial opposition, the vibrations produced will be opposite in direction and substantially in phase. Therefore, the vibrations transmitted from the subwoofers 53 and 54 to the first enclosure 30 substantially cancel each other. Acoustical ports 47 may be used to reduce pressure within first enclosure 30, thus further reducing vibration to surrounding components. Illustrated in (FIG. 2) acoustic ports 47 may be mounted on first enclosure 30 walls 44 and 46. Said acoustical ports 44 and 46 may be mounted to first enclosure 30 front 42 or back 50 walls.

Because the first enclosure 30 is designed to be both a stand as well as a speaker enclosure, the first enclosure 30 may be larger than prior art speakers but smaller than prior art home entertainment systems. If the first enclosure 30 were a stand-alone speaker unit, it would be regarded as unduly bulky. Commercial appeal of such a unit would be reduced. However, due to the number of functions provided, the first enclosure 30 will warrant greater consumer acceptance as it may be much smaller than traditional home entertainment systems. Since the first enclosure 30 acts as a soundboard, for a given size speaker, a smaller amplifier and smaller magnet driver can be used than would be necessary in the smaller sized enclosure normally associated with the given size speaker.

The front panel 42 (FIG. 2) provides portions of the home entertainment system 10 with which the user 4 may interact. These portions include a group of controls 60. The controls 60 may include on-off switches, component selectors, volume controls and other controls. The user 4 may operate the selected ones of the controls 60. Alternatively, the user 4 may operate the remote control unit 6 to perform selected tasks. A sensor 61 is mounted in the front panel 42 of the first enclosure 30 to receive signals from the remote control unit 6. The sensor 61 interfaces with a remote control circuit further described below. The sensor 61 is selected to be compatible with the remote control unit 6. For example, the sensor 61 may comprise an infrared sensor, and the remote control unit 6 may transmit pulses on an infrared carrier.

A number of components have portions mounted for access or display at the front panel 42. A disc player/recorder 62 includes a door which may be opened to receive one or more CDs or DVDs. The disc player/recorder 62 could comprise a disc changer which can hold a plurality of discs,.playing a selected disc in response to a command. Alternatively, an optical media player/recorder other than a disc player may be used. A display 66 may take any of a number of forms. The display 66 may include fields to display information concerning the media being played, such as title and elapsed or remaining time on a track. The display 66 may be coupled to a radio tuner and display frequency and band to which a tuner is set. The display 66 may also include a text field for radio broadcast signals that provide text information. The display 66 may also include setup controls for the surround sound and room equalization.

If desired, other, separate components may be interfaced to the home entertainment system 10. The front panel 42, the rear panel 50 or both may comprise further input means to receive further media signals for processing by components in the home entertainment system 10. In the FIG. 2, a group of input ports 68 is provided on the front panel 42 to receive a variety of inputs. A currently preferred form of input port is a USB port. However, new standards continue to evolve, and another form of port may be provided. A digital media reader input and output (I/O) and audio/video (AN) I/O 64 may be provided on the front panel 42 as well. As seen in FIG. 3, additional (I/O) sockets and jacks 72 are provided in the electronics plate 56. The additional input sockets and jacks 72 may be provided in accordance with any of a number of analog or digital protocols. The integrated disc recorder and/or DVR may record media from any one of the digital media or A/V inputs. Audio outputs 74 may be provided on the electronics plate 56 for interface to speakers. A subwoofer volume control 78 may also be mounted in the electronics plate 56. Subwoofer crossover adjustment 79 and phase adjustment 80 may be mounted to electronics plate 56. Additionally, a line cord 76 communicates through the electronics plate 56 to supply AC power to the home entertainment system 10.

FIG. 4 is an axonometric view of the housing unit 36. As mentioned above, the center channel 16 is housed in the center channel enclosure 39. The center channel enclosure 39 is supported on the first enclosure 30. The center channel enclosure 39 may either be modular or unitary with the first enclosure 30. The upper support base 88 spans a top of the center channel enclosure 39. The modular shelf unit 38 comprises an open box 84 having an inner support surface 86 on which the subscriber interface unit 14 (not shown in FIG. 4) or other apparatus may be placed. The center channel enclosure 39 has an upper support surface 87. It is generally desirable to have the center channel enclosure 39 situated above the modular shelf unit 38 so that the source of sound is closest to the video display 12. If desired, the modular shelf unit 38 could be over rather than under the center channel enclosure 39.

In the illustration of FIG. 4, the upper stabilizing base 88 extending horizontally past either side of the housing unit 36. The upper stabilizing base 88 is fastened to the housing unit 36. Many different forms of fasteners could be used. In the present illustration, screws 90 extend through apertures 92 and are each received in a threaded aperture 94 (FIG. 3). The modular shelf 38 may be removable by apertures 92 each in registration with a threaded aperture 94 adjacent a corner of an upper surface of the housing unit 36. Similarly, apertures 92 are provided in the surface 86 of the modular shelf unit 38 each in registration with a location with a threaded aperture 94 adjacent a corner of an upper surface of the center channel enclosure 39. The upper stabilizing base 88 may be removable in order to allow substitution of alternate upper stabilizing bases 88 to accommodate a wide range of television bases. Alternatively, a smaller television may be supported directly on the upper support surface 87.

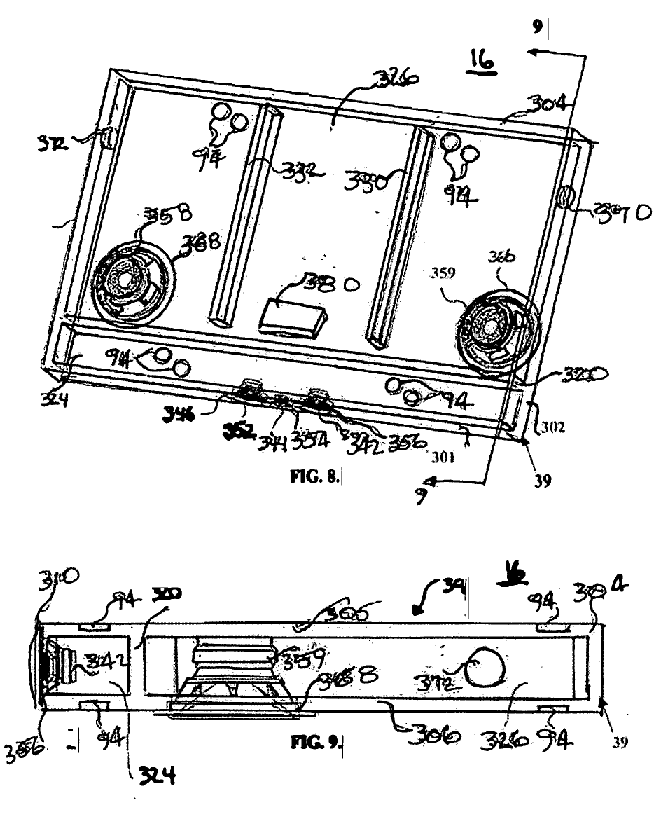

The structure of the present embodiment permits the center channel enclosure 39 to be wider than the first enclosure 30. This larger horizontal dimension allows for use of larger speakers than many prior art center channel units in an enclosure, and provides a larger than normal enclosure volume. The midbass driver further described with respect to FIGS. 8 and 9 below may be mounted in portions of the center channel enclosure 39, which overhang the first enclosure 30. Acoustical obstruction by the first enclosure 30 or by the modular shelf 38 is avoided. This construction lends itself to match the “single speaker surround sound” format. The center channel enclosure 39 in the preferred form has a slim height and large width yielding a form, which is generally regarded as aesthetically pleasing.

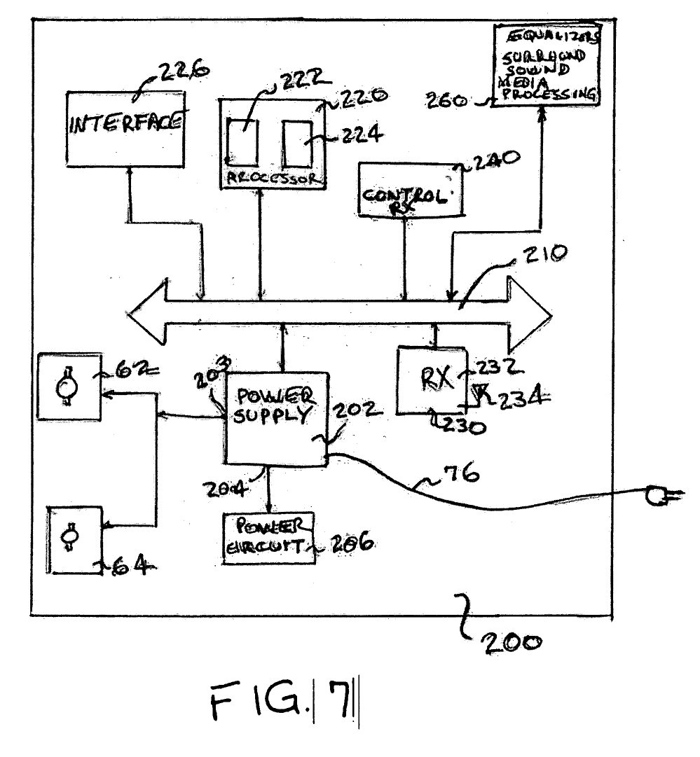

The components of the home entertainment system 10 are illustrated in FIGS. 5 and 6. FIG. 5 is a cross sectional elevation taken along line 5-5 of FIG. 2 illustrating an interior 98 of the first enclosure 30. FIG. 6 is a plan view of the apparatus of FIG. 5. The plurality of modules may be embodied in many ways. A plurality of chassis, each comprising a different module could be provided inside the first enclosure 30. In another form, the modules may comprise separate circuit boards, each circuit board being associated with a particular function, integrated in a multifunction unit and connected to a common power supply. The modules may easily be upgraded or replaced in the event a unit fails. This prevents replacing the entire unit, instead only the component needing upgrade or repair. In a further embodiment, for example as illustrated in FIG. 7, one circuit board may be associated with a plurality of modules. For example, a processor board could be provided to do signal processing for a plurality of modules. Processing capacity may be shared between boards such as a tuner and a surround sound unit rather than providing a separate processor on each board.

As seen in FIGS. 5 and 6, a bracket 100 is fixed to the inner surface of the electronics plate 56 and supports a card cage 102. The card cage 102 supports selected circuit boards which together provide the functions of various modules and which provide interfaces to media source inputs and audio outputs. The functions assigned to various boards in the present illustration are representative of the different forms that may be provided. Components performing a particular function may be distributed over a plurality of boards. It is also possible to centralize a performance of function on a single board serving each module. In the present illustration, a power supply card 110 is supported in the card cage 102 and connected to the line cord 76. The power supply card 110 comprises power-conditioning circuitry 112.

The power conditioning circuitry 112 generates heat. Heat exchange apparatus 114 is mounted on the card 110 adjacent the power conditioning circuitry 112 to dissipate heat. Depending on power dissipation of the power supply 110 and an amplifier further described below, the heat exchange apparatus 114 may or may not include radiation fins. In selected embodiments, the heat exchange apparatus 114 may be thermally coupled to or comprise a portion of the electronics plate 56 (FIG. 3). Well-known forms of heat exchange apparatus may be used. The selection will be dependent on the heat sensitivity of modules to heat and the power level dissipated by the power-conditioning circuitry 112. In many applications, heat-radiating fins will be suitable. Other applications may utilize active cooling components such as fans or heat pipes. The power supply card 110 replaces the separate power supplies that would each be included in discrete modules.

The provision of a single power supply reduces component count, the number of connectors that must be provided and the volume occupied by power supply circuitry. Nominal module power supplies have efficiency levels of 30% to 60%. In one preferred form, the power supply 110 is a switching power supply. A nominal efficiency level for a switched power supply is 60% to 90%. A switched power supply is capable of converting differing input voltage levels.

A digital media reader card 64 may be connected through cable 138 to board 190 on the card cage 102. Digital media player/recorders may read many different forms of media, such as movies, photographs, audio and video camera outputs. A cable 132 may couple the disc drive 62 to the digital media reader card 130. Decoded sound signals are processed by a processor and sent to an amplifier card 150 for provision of audio signals to speakers. The amplifier card 150 may include preamplifiers or may receive an input from a preamplifier on another circuit board. In one embodiment, the amplifier card 150 is also mounted to make use of the heat exchange apparatus 114. The amplifier card 150 will comprise at least one amplification channel. Outputs from the amplifier card 150 are provided by a cable 134 to the audio speaker terminal bank 74. Other output interfaces could be provided. Further sound processing is provided by a surround sound processing card 160. The surround sound processing card 160 includes at least one surround sound decoder. In many applications, the number of amplifier channels in the amplifier card 150 will be a function of the surround sound decoder capabilities.

A receiver card 170 is coupled by a cable 136 to receive signals from the sensor 61 in response to inputs from the remote control unit 6 and converts inputs from the control unit 6 to control activation of selected modules and selected operating functions within modules. A tuner card 104 may be provided to tune to selected radio bands. Currently popular bands include FM, AM radio and satellite radio provided by such services as Sirius and XM radio. Further interconnections may be provided via an interface board 190. The interface board 190 may steer signals as appropriate between the other circuit cards and may be coupled to a group of cables 140 to interface all other inputs and outputs to the home entertainment system 10.

FIG. 7 is a block diagram of one form of integrated entertainment system. In FIG. 7, an integrated system 200 is illustrated on a single circuit board. The same reference numerals are used to denote components corresponding to those in FIGS. 1-3. The line cord 76 is connected to a power supply 202. The power supply 202 provides drive mechanism power from a terminal 203 to drive mechanisms such as the disc player/recorder 62. The power supply 202 also provides high-level power to components illustrated as a power circuit 206. Components drawing high levels of power include audio amplifier channels. Additionally, the power supply 202 provides power to integrated circuitry and processors in the integrated system 200. This provision of power is illustrated as a connection to a bus 210. Data and control signals are transmitted over signal-carrying portions of the bus 210. A central processing unit 220 coupled to the bus 210 comprises a data memory 222 and a program memory 224. The program memory 224 comprises programs for decoding digital signals representing audio and video signals. Alternatively, the functions performed could be depicted by illustrating a decoder for each form of signal to be processed. While the integrated system 200 will generally be used to process only one medium at a time, multiplexing capabilities may be provided to process more than one medium at a time. An interface circuit 226 is coupled between the media sources such as disc player/recorder 62 (FIG. 2) and the bus 210 in order to coordinate timing of signals to be processed and to match input impedances to the bus 210.

A tuner chip 230 comprises a coupler 232 which connects to an antenna 234. The antenna 234 may comprise an array of multiband antennas. The tuner chip 230 may include an FM, AM and satellite section. In the present embodiment, video tuning is done by a tuner in the television set 12 (FIG. 2). However, a separate video tuner could be provided in the integrated system 200. Additionally, a receiver chip 240 is provided to respond to control signals from the remote control unit 6. The processor 220 may interpret the control signals and direct selected signals accordingly. A media circuit 260 illustrates additional audio, video and other processing functions.

FIGS. 8 and 9 illustrate the center channel speaker unit 16 housed in the center channel enclosure 39. For purposes of illustration, the center channel enclosure 39 is shown as having transparent walls, for example of Lucite or Plexiglas. FIG. 8 is an axonometric view. FIG. 9 is a cross sectional side elevation taken along line 9-9 of FIG. 8. The center channel enclosure 39 has a front wall 301, right and left side walls 302 and 303, a rear wall 304 and upper and lower walls 305 and 306. The center channel enclosure 39 may conveniently be made of a number of different materials. Suitable plastics include polyvinyl chloride (PVC) and acrylonitrile butadiene styrene (ABS). Other suitable materials include extruded aluminum and wood. A speaker grille 310 (FIG. 9) may be mounted in front of the front wall 301. A midrange-midbass divider wall 320 parallel to the front wall 301 divides the center channel enclosure 39 into first and second chambers 324 and 326. In the chamber 326, first and second braces 330 and 332 are provided to support weight transmitted from apparatus supported above the center channel enclosure 39.

In the embodiment of FIGS. 8 and 9, the center channel speakers comprise a right mid range speaker 342, tweeter 344 and left mid range speaker 346 received in apertures 352, 354 and 356 respectively in the front wall 301. Preferably, the tweeter 344 is centered in the front wall 301, and the right mid range speaker 342 and left mid range speaker 346 are symmetrically spaced from the tweeter 344. Right and left midbass speakers 358 and 359 are supported to the lower wall 306. The speakers 358 and 359 project sound through apertures 366 and 368 respectively. The right and left midbass speakers 358 and 359 are preferably placed symmetrically and sufficiently close to the right and left walls 302 and 303 respectively so as to overhang the modular shelf 38 and the first enclosure 30. Consequently, sound is delivered into the air and is not muffled by enclosure walls. Midbass ports 370 and 372 in the right and left walls 302 and 303 respectively allow for air movement created by flexing of cones in the midbass speakers 358 and 359. A crossover circuit 380 distributes various drive signals to appropriate ones of the speakers 342, 344, 346 358 and 359.

The arrangement of FIGS. 8 and 9 is exemplary, but other numbers of speakers could be included. Speaker systems with additional speakers are gaining in popularity in use. Many different arrangements of modules may be provided in order to construct embodiments of the present invention. At a minimum, the home entertainment system 10 will comprise audio and video player/recorders and amplifiers.

The present subject matter being thus described, it will be apparent that the same may be modified or varied in many ways. Such modifications and variations are not to be regarded as a departure from the spirit and scope of the present subject matter, and all such modifications are intended to be included within the scope of the following claims.

What is claimed is:

1. An integrated home entertainment system comprising:
a plurality of entertainment modules comprising at least a media source, an amplifier and a decoder;
at least one power supply for a plurality of said modules; and
a modular base housing said modules.

2. A system according to claim 1, wherein said modular base comprises a television stand having a support surface.

3. A system according to claim 2, wherein said modular base comprises a housing unit intermediate said first enclosure and said support surface and where said modules are housed in said first enclosure.

4. A system according to claim 3, wherein said housing unit comprises a shelf module and a center channel enclosure.

5. A system according to claim 4, wherein said center channel enclosure is located above said shelf module.

6. A system according to claim 5, wherein said center channel enclosure overhangs said first enclosure.

7. A system according to claim 6, wherein said center channel overhangs said shelf module.

8. A system according to claim 7, wherein first and second speakers are mounted in portions of said center channel enclosure overhanging opposite sides of said shelf module respectively.

9. A system according to claim 5, wherein said center channel enclosure has a height to accommodate a tweeter and midrange speaker and a width equal to at least a width of the shelf module plus a width of two midbass speakers.

10. A system according to claim 3, further comprising at least one subwoofer supported in said first enclosure.

11. A system according to claim 10, comprising first and second subwoofers mounted in mutual registration in opposite walls of said first enclosure.

12. A system according to claim 2, wherein said support surface is releasably locked in engagement to be supported to said housing unit.

13. A system according to claim 2, further comprising a center channel enclosure intermediate said first enclosure and said support surface.

14. A system according to claim 13, wherein said center channel is located between said modular shelf and said support surface.

15. A system according to claim 13, wherein said housing unit is removably fastened to said first enclosure.

16. A system according to claim 14, wherein said center channel is comprised of said center channel enclosure.

17. A system according to claim 12, wherein said support surface has a preselected size to accommodate a preselected television base.

18. A system according to claim 2, wherein said first enclosure further comprises media input ports.

19. A system according to claim 14, wherein said support shelf comprises an upper surface of said center channel.

20. A system according to claim 2, further comprising a receiver mounted in said first enclosure to receive remote control signals, a remote control unit to provide signals to said receiver, and a control circuit to operate said modules in response to the remote control signals.

21. A system according to claim 1, wherein said modules comprise an integrated unit wherein said modules are embodied by circuit boards commonly powered and wherein at least first and second heat-generating circuit boards are thermally connected to a common heat dissipation apparatus.

22. A system according to claim 21, wherein said modules comprise circuit boards each dedicated to one function of a home entertainment system.

23. A system according to claim 21, wherein said circuit boards comprise common functions and wherein at least one said circuit board services a plurality of channels.

24. A system according to claim 23, wherein said modules comprise an audiovisual source, audiovisual processing circuitry, a power amplifier channel and interface to provide signals to speakers.

25. A system according to claim 23, further comprising an input for connection to a microphone detecting sound in an environment supplied by said system and an audio processing circuit to process audio in accordance with a rule in response to an input from said microphone.

26. A system according to claim 25, further comprising a remote control receiver coupled to provide inputs to said modules and a remote control transmitter remote from said first enclosure.
